(19) United States
(12) Patent Application Publication
(10) Pub. No.: US 2009/0204402 A1
(43) Pub. Date: Aug. 13, 2009

(54) METHOD AND APPARATUS FOR CREATING CUSTOMIZED PODCASTS WITH MULTIPLE TEXT-TO-SPEECH VOICES

(75) Inventors: Harpreet MARWAHA, Santa Monica, CA (US); Brett ROBINSON, Seattle, WA (US)

Correspondence Address: WILMERHALE/BOSTON, 60 STATE STREET, BOSTON, MA, 02109, US

(73) Assignee: 8 FIGURE, LLC

(21) Appl. No.: 12/351,675

(22) Filed: Jan. 9, 2009

Related U.S. Application Data
(60) Provisional application No. 61/020,029, filed on Jan. 9, 2008.

(51) Int. Cl. G10L 13/04

(52) U.S. Cl. 704/260; 704/E13.005

(57) ABSTRACT

Method and apparatus for creating customized podcasts with multiple voices, where text content is converted into audio content, and where the voices are selected at least in part on words in the text content suggestive of the type of voice. Types of voice include at least male and female, accent, language, and speed.

### CROSS-REFERENCE TO RELATED APPLICATION

This application claims priority to provisional application Ser. No. 61/020,029, filed Jan. 9, 2008, which is incorporated herein by reference.

### FIELD OF THE INVENTIONS

The present invention relates generally to text-to-speech (“TTS”) podcasts. More specifically, the present invention relates to text-to-speech podcasts that utilize multiple voices and incorporate music and advertising.

### BACKGROUND

Newspapers, magazines, and other traditional subscription-based services are experiencing hard copy declines while online subscription and readership numbers are increasing. This change impacts both subscription and advertising revenue.

At the same time, user-generated content and social media is thriving through blogs, podcasts, pictures, videos, social networking services, and RSS (Really Simple Syndication), a web feed format for content distribution. As a result of these conditions, marketers are looking for emerging channels through which to spend advertising dollars and have increased amounts spent on these mediums.

A podcast is a digital media file. Podcasts can be audio files, such as in the MP3, WAV, WMA, or AAC formats by way of nonlimiting examples. Podcasts can also be video files, such as in the MPEG, MP4, MOV, or RealMedia formats by way of nonlimiting examples. Podcasts that are video files can have audio portions and video portions.

Text-to-speech technology converts electronic text content into electronic audio content. By way of nonlimiting example, text-to-speech technology could receive as input text from a website and produce as output an audio file of a computer-generated voice reading the input text.

### SUMMARY

The inventions described here relate to a service that bridges traditional and digital media. The system can meet needs of consumers, content providers, and advertisers. Consumers can get a service that can provide content in a format they want, when they want it. Content providers can get new ways to monetize existing content onto new channels. Finally, advertisers can work with service providers that have the ability to deploy advertising on new media and measure its impact. The services, referred to herein as AudioDizer and VideoDizer, enable content providers to leverage their content, redistribute it in audio and video format, and support it with advertising.

In one aspect, a service takes text content from any media source as input and converts it to an audio file using text-to-speech technology. The output is an audio file of the text content that can contain music and advertising commercials and that can be distributed. In another aspect, a service takes text content from any media source as input and also takes as input any additional multimedia associated with the content of the text (images, videos, charts, tables, graphics, logos, text, etc). The output is a video file that contains an audio portion and a video portion. The audio portion can be a combination of text-to-speech, music, advertising, and any other audio content. The video portion can include images, videos, tables, charts, graphics, and logos. The result is a video file that displays relevant multimedia with corresponding audio. Another aspect relates to the advertising that is placed within the audio and video files. This portion of the service creates the advertising, inserts the appropriate message within the files, and manages the scheduling of these messages.

In one aspect, the system creates video files with audio portions similar to MP3 podcast and video portions that incorporate visual media such as images, tables, charts, graphics, videos, and logos. In another aspect, the system creates advertising messages using the same technology and manages the scheduling and placement of advertising within the digital files.

In some aspects, the invention is a method of receiving text content from a media source, converting the text content into audio content such that the audio content allows a user to listen to an audio version of the text content, the conversion using text-to-speech technology in which one or more of a plurality of text-to-speech voices can be used to convert the text content, creating a podcast file from the audio content, wherein the converting includes identifying one or more words within the text content and wherein the text-to-speech voices are selected automatically based at least in part on the identified words in the text content. The text-to-speech voices can be representative of both male and female voices, different reading speeds, different geographic locations, and multiple languages, any of which can be selected based a least in part on text content indicative of the text-to-speech voices. In other aspects, the invention is a system comprising an interface for receiving text content from a media source, and a processor for converting the text content into audio content such that the audio content allows a user to listen to an audio version of the text content, the conversion using text-to-speech technology in which one or more of a plurality of text-to-speech voices can be used to convert the text content, and for creating a podcast file from the audio content, wherein the processor for converting identifies one or more words within the text content and wherein the text-to-speech voices are selected automatically based at least in part on the identified words in the text content.

These aspects are implemented with the following desirable characteristics in mind, although a system would not need to have all of these characteristics:
Automation—low cost to produce; can be used with existing media
Flexibility—can support multiple media types as input and output
Enabled with advertising—allows media companies to monetize the channel
Personalized—media can be personalized with music and branding
Portability—can be viewed online or offline on any media enabled device including mobile phones, iPods, etc.
Scalability—can produce, host, and integrate several media types for any size client
Accountability—provide consistent up time and reporting capabilities
Quality—produce high quality and unique experiences for consumer content

### BRIEF DESCRIPTION OF THE DRAWINGS

FIG. 1 illustrates an audio podcast according to one aspect of the invention.

FIG. 2 illustrates the phonetic capabilities of the service according to another aspect of the invention.

FIG. 3 illustrates a podcast created from individual files, along with transitions, according to yet another aspect of the invention.

FIG. 4 illustrates a more complex audio podcast according to an aspect of the invention.

FIG. 5 illustrates an even more complex audio podcast according to another aspect of the invention.

FIG. 6 illustrates a sample video file according to yet another aspect of the invention.

FIGS. 7A and 7B illustrate how an audio file may change over time according to an aspect of the invention.

FIG. 8 illustrates the architecture of the service according to some aspects of the invention.

### DETAILED DESCRIPTION

This detailed description relates to aspects of the service that include the audio, video, and advertising components. Many of the details described in the audio portion of this aspect of the invention will also be applicable to the video and advertising aspects of the inventions because they are based on the same foundation of hardware and software programming.

In order to create and output an audio or video file the service requires content. Any form of content can be submitted to the service by a client. The content could be a website, blog, newspaper, magazine, journal, book, movie or play script, research report, instructions, email, newsletter, an instant message, text message, or any similar form of content. The content can be submitted in any format including, for example, a Word document, PDF, PowerPoint presentation, RSS feed, website, etc. If the client's content is submitted to the service via RSS feed, the service can monitor the RSS in order to determine whether or not it has been updated. Every time the client updates content on their end the RSS feed will also be updated. The service will be able to subscribe to the RSS feed and pick up changes automatically. Content providers can also ping the service to let it know that new content is available. This can be done via a web service or a remote procedure call (“RPC”) that listens for the client request. Both audio files and video files can be generated from the information contained in RSS feeds or through the content that is submitted.

Once the content has been submitted, the service begins processing the text and images. There are a series of tasks the service can perform in order to get the desired output. All of these tasks can be customized and defined by either the content provider or the consumer. The service provides a set of default features in case no preferences are chosen. The service will parse through the content and separate and tag elements of the content and store these elements in a database. For example, the service will separate the title, author, description, and body text for a news article. If the submitted content includes URLs to other files, images, tables/charts, or videos, the service will also separate and tag each of the multimedia associated with the content. The service uses the text to create the audio and the multimedia for the video portion of the service.

The service can then apply some or all of the customized features to the content. These features include using multiple text-to-speech voices, changing the speed of the output (rate at which the voice reads the content), changing output size of file (bit rate and encoding), changing file output (output to various formats including MP3, WAV, MPEG, WMV, FLASH, etc), correcting the pronunciation of words, adding transitions, and adding music. For video files, in addition to the features mentioned above, the service can also conduct internal and external searches for additional multimedia that can be associated with files, add visual effects to multimedia, and adjust and create timeframes for when to display the associated media.

According to some aspects of the invention, an XML based timeline is created for each of the articles. This XML based timeline keeps track of all the changes, preferences, and features for each outputted file. The timeline lets the service know when to add in and process all the effects (fade in, fade out, background music start/end, etc) and how many different files it needs to create so it can merge the collection of files into either an audio or video file. The XML timeline for the video file includes additional details on which multimedia file should be displayed, for how long it will be displayed, and any visual effects that go along with the display (graphics fade in/out, fly in/out, etc).

For multiple TTS voices within a single article, the service will add SAPI (speech application programming interface) references within the text that will notify the text-to-speech server to change the voice when it is being processed. Alternatively, the service will output multiple files for each part that uses a different voice. These pieces will then be combined at the end of the processing so that the consumer or content provider receives only one cohesive file that includes their content. The voices can include distinctions such as male and female voices, multiple accents, such as British, Indian, etc., and multiple languages. The service can mix different brands of text-to-speech voices to work together. The service can further use smart switching between any of these distinctions. For example, the sex of the voice can be based on forward searching in an article for keywords, such as “he said,” and names. The accent or language used can also be set based on location. For example, in a news article in which the location is specified as “London, UK,” the service can use a British accent while a location of “Los Angeles, Calif.” could trigger an American accent. The service can also search for quotes and determine by the name of a person or by a pronoun associated with a quote whether to use a female or a male voice. For example, the words “he said” or “Jill mentioned” could trigger a male voice or a female voice respectively. Any time a new voice is utilized, the service generates a separate audio file for that voice. For example, to have a title read by a male voice and an author's name read by a female voice the service will output two separate audio files—one for each part. After all the files are produced, the service merges all of the audio files into one cohesive file which is eventually outputted to the client. Users can also personalize their choices of voices as above and store their preferences in a database so that articles are processed with their preferred voice. The service can additionally use a translation service to translate content into different languages and create the desired output files.

Along with the preferences of what TTS voice should be used, the content provider or consumer can also select their preference on the speed at which the voices read the content. Furthermore, the encoding/bit rate (which affects the quality and size of a file) as well as file output types can be defined by the content provider or consumer. Clients can also create mobile versions of a particular file that can be encoded differently to create a smaller version of the same file. These are variables that are provided by the text-to-speech vendor and can be manipulated in the programming. This preference is stored in the database so that any time a file is processed the appropriate change will be applied.

The service also has the capability to improve the pronunciation of words and utilizes a phonetic dictionary. The phonetic dictionary is a database of words that is stored on the application servers that contains a word and its phonetic spelling. The phonetic dictionary can be used to perform the following tasks:
change mispronounced words by replacing them with improved phonetic spelling;
change the sound of a normal word to sound the way a client prefers, including for the names of authors, companies, or products, and including placing an emphasis on a selected part of a word to create a personalized sound experience;
maintain a list of words in a database with the phonetic spelling of each word such that the service can search for all such words within text and replace them with the associated phonetic spelling;
use a standard vocabulary across all clients and produced files;
create a database of words that is updated regularly either by the service or by users of the service;
create rules for specific types of words, including phrases, states, dates, slogans, etc; and
create rules for specific types of grammar, including inserting commas and splitting up words with multiple syllables.
   The service does this by searching through article to find the words or phrases (as mentioned above) and replacing them with the correct phonetic spelling. For example, finding the word “eBay” and replacing it with “E. Bay” so that the text-to-speech engine pronounces the word correctly.

The insertion of transition words is done through a similar process. For example, after the title of an article, the service can append “an article by” followed by the author's name. The insertion and replacement of words is done before the text is submitted to the text-to-speech engine to be read out loud. The words that are inserted are intended to improve the overall listening and watching experience of the files. This creates a more radio like show or theatrical play type of experience. Once all updates to the text have been made the text is then submitted to the text-to-speech engine to create the audio files.

The service has the capability of integrating music throughout the audio file, including adding audio effects, to emulate a radio show. The music can be placed anywhere within the file, including the beginning (“pre-roll”), the end (“post-roll”), or anywhere in-between. The music can be played in the background as text is being spoken. The music can be a professional or amateur recording, and can be used for promotional purposes, such as a new song release, or for a commercial. Adding music is done via a similar process mentioned above. The music is placed in a separate file and based on whether it is for an intro or an outro, the music file is merged in the beginning or end with all the audio files in order to generate the final output.

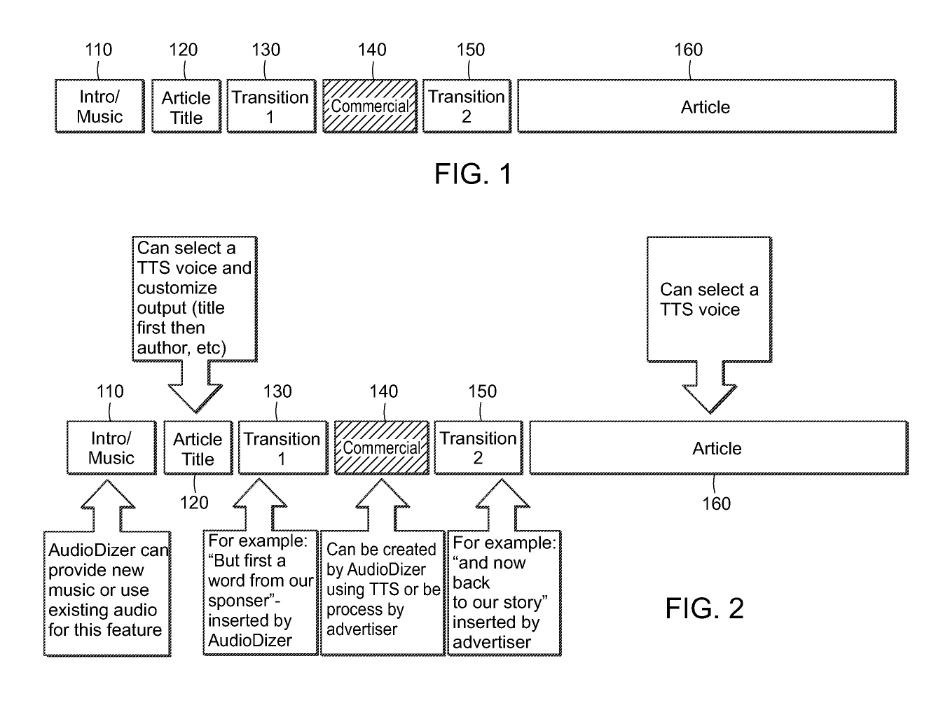

Once all the features to the audio are in place, all the audio files get merged into one cohesive file and is delivered to the web server. FIG. 1 illustrates a basic audio file that the service (referred to as AudioDizer in the figure) may create. The output audio file is made up of introduction audio file 110, title audio file 120, first transition audio file 130, commercial audio file 140, second transition audio file 150, and article audio file 160.

FIG. 2 illustrates the phonetic capabilities of the service. The service can provide introductory music and/or use existing audio to create introduction audio file 110. The service allows for the selection of a TTS voice for title audio file 120, and further customize the output by specifying the order in which the title is read. Exemplary text for first transition file 130 is shown below the box representing that file. Commercial audio file 140 can be created by the service using TTS or can be provided by an advertiser. Exemplary text for second transition file 150 is shown below the box representing that file. Finally, a user can select a TTS voice for article audio file 160.

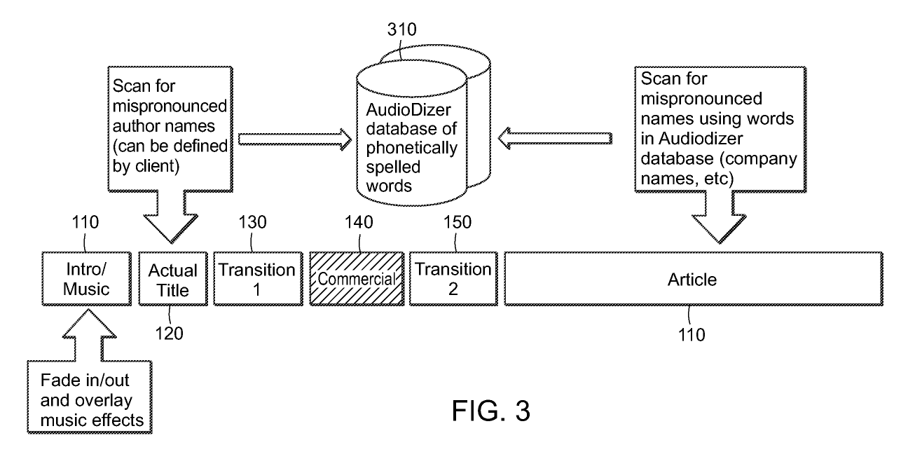

FIG. 3 illustrates a podcast that the service, AudioDizer in these examples, can create from individual component files, along with transitions between the individual components. Fade in, fade out, and/or overlay musical effects are illustrated for introduction audio file 110. Title audio file 120 and article audio file 160 are scanned for mispronounced author names, as can be defined by a client. Audio files are scanned for mispronounced names by searching phonetic database 310.

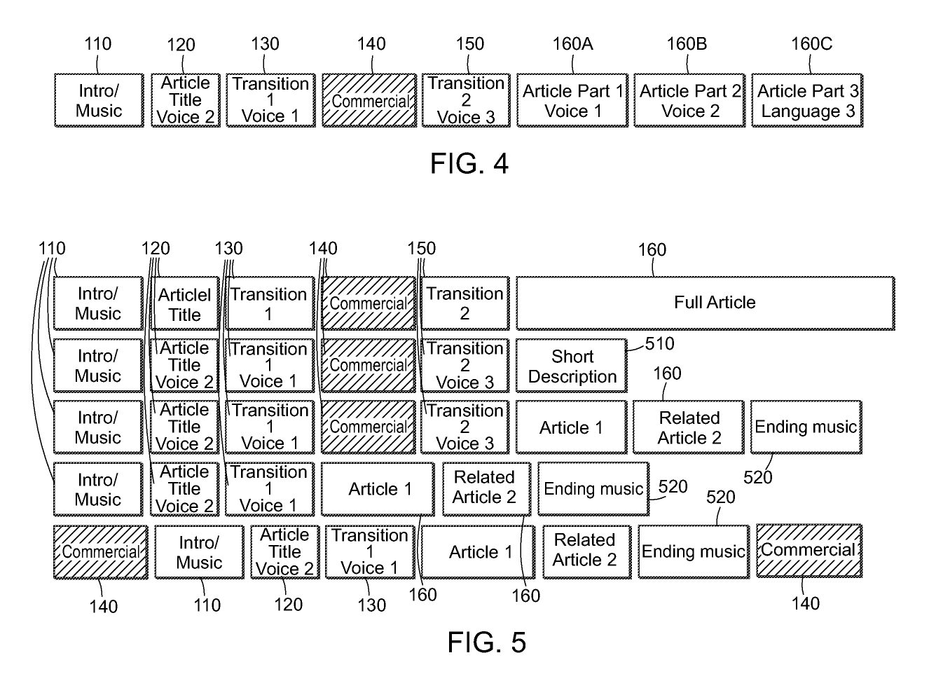

FIGS. 4 and 5 illustrate increasingly complex files that can be created by the service. Each of the rectangles in the figures represents a separate audio or video file that is created to generate the effects listed. All of these separate files are merged together in order to create one file that can be accessed by the consumer. As illustrated in FIG. 4, the article portion of the podcast is made up of first article part 160A, second article part 160B, and third article part 160C. As also illustrated, article part 160A is read in voice 1, article part 160B is read in voice 2, and article part 160C is read in a different language, language 2.

FIG. 5 illustrates an audio podcast file made up of multiple introduction audio files 110, multiple title audio files 120, multiple transition audio files 130, multiple commercial audio files 140, multiple transition audio files 150, multiple article audio files 160, as well as short description audio file 510 and multiple ending music audio files 520. As illustrated in the figure, TTS audio files can be in different voices, as well as in different languages. Each row represents a different format that the service can output.

The service-created files can be shortened files, including, for example, only the title and the first sentence of a full article. They can also be summary files that include, for example, the title and a summary of the article. The service can also combine multiple stories into one output file. These stories can be from the same source or from a plurality of sources. As examples, an article can be combined with a weather forecast or with a stock quote. The service can also combine relevant stories together to create a single file. All of these story features are defined by the client as part of using the service.

If a file is slated to be in a video format, however, more processing is required. The video portion can be broken down into two components—the audio layer and the video layer. The audio layer incorporates the audio functionality (described above), and the video layer uses additional multi-media associated with a typical article to create video. As an example, from a sports article written about a famous athlete, the service can create an audio layer from the service and features described above, and the video layer can additionally include media such as photographs, video highlights, tables, charts, text from article, advertising banners/video, and game/player statistics as the video portion of the overall file. The overall experience that is generated is that as consumers are listening to the sports story, they can see the corresponding relevant images and media on their device.

As mentioned above, the XML timeline that is generated for a video file includes all the information the service needs to process the multimedia and have it displayed. To get it to display at the relevant moment, the service tags keywords found in the text that relate to the multimedia. For example, any time the service finds the name “Kobe Bryant” in a sports article, the XML timeline will be marked and the relevant image of “Kobe Bryant” will be added. Therefore, when processing, the service will know exactly when to display the relevant image. The service keeps track of keywords that can trigger a multimedia file to be displayed in a database. The service is also set up to search for relevant images on the web based on text, and work with third-party image and video services, such as Flickr and YouTube, to obtain relevant images based on the context of the article and the tags of the associated pictures. This is particularly useful for situations where the content provider only has text but no media for the article. By affiliating the service with third-party applications or vendors, the service will have access to a larger number of media files that can be inserted as the video layer on any audio file. The service has the capability to store an archive of images to select the type of image to use for any particular device. Based on this, the service can intelligently create files for different devices so the appropriate graphics can be used. As an example, a cell phone may require a lower resolution or lower quality file than an MP3 player.

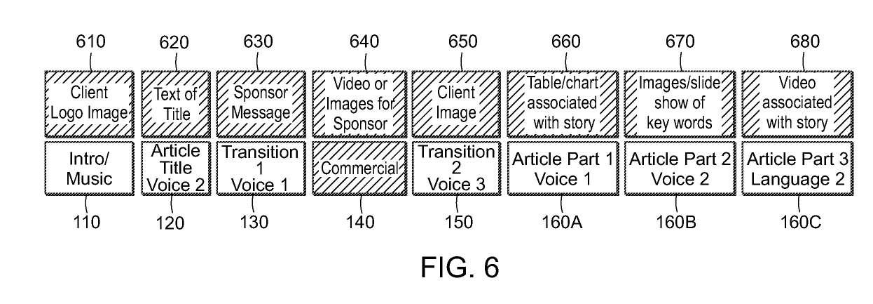

FIG. 6 illustrates a sample video file that the service can create. The bottom row of FIG. 6 represents the audio layer of the final file. The top row of FIG. 6 represents the multi-media, or video, layer of the final file. As above, each rectangle in the figure represents a separate audio or video file that is created to generate the effects listed, and all of these separate files are merged together to create one final file that can be accessed by the consumer. The first portion of the file that is represented below will have client logo image 610 displayed visually while introduction audio file 110 is heard audibly. The next portion of the file will show the text of the title 620 visually while title audio file 120 is read in Voice 2 audibly. So, each multi-media portion of the file, represented by rectangles in the top row, is displayed while the associated audio portion of the file, represented by adjacent rectangles in the bottom row, can be heard in the file. As such, sponsor message 630 is displayed visually while first transition audio file 130 is played audibly; sponsor video 640 is displayed visually while commercial 140 is played audibly; client image 650 is displayed visually while second transition audio file 150 is played audibly; table 660 is displayed visually while article part 160A is played audibly; slideshow 670 is displayed visually while article part 160B is played audibly; and video 680 is displayed visually while article part 160C is played audibly. Once the timeline is set (the timeline can be defined by the client or customer), all the individual components—audio files and multimedia files are processed using video rendering software tools such as Microsoft DirectShow. The resulting output file is a video that has audio with visual multi-media that change according to the defined timeline. The output can be in any video supported format including WMA, MPEG, WMV, MP4, Flash, etc. When merging a visual layer with an existing audio file the same timeline process is used.

There are many methods the service can use to display the associated multimedia with the audio layer. These methods can be personalized by user or by the client. The service can customize the length of time an image or any other media is displayed and can change the topic of the video as indicated by the article or by key words. The display length of any still image or video portion can be based on the number of images within the article. For example, if the audio is one minute long and there are six images associated with the subject, each image could be displayed for ten seconds. The service can format and crop images so that they are displayed properly and meet client requirements. The service can use a variety of effects to enhance the viewing experience, by, for example, overlaying graphics one on top of another in order and animating graphics so they fly or fade in or out. The service can create templates that can be used for certain types of slideshows. For example, the service could have a background for an image or a frame. Also, depending on the device, a user can select an image while the video is playing and can be taken to a website containing additional relevant information. In this case the image would function as an URL to access another website.

The service can also create a video file out of an existing audio-only file. An existing audio file includes professionally recorded songs or music, podcast, speech, or any audio recording. The service can also create enhanced podcasts, using speech recognition to convert audio to text in order to work with existing podcasts to enhance them with images and other content. As an example, the service can take a podcast from a public radio station, transcribe the audio, and link the audio to images, to video, or to any other media in order to generate a video file. The service can also get the lyrics of a song to display relevant images for that song. For example, the service can display sponsored advertising while music is playing, can display pictures based on music lyrics that are being played, and can add video content to speeches and classroom lectures. The service can also append video created by the service to existing video. Other examples of videos that can be produced by the service include image slideshows, comic book slideshows, presentations, etc. It can scroll text horizontally, vertically, or any other direction. It can vary the amount of text displayed, so that one word, one sentence, or multiple sentences can be viewed at any given time. It can display text in any font, color, or size, including using the same formatting as the webpage or document from which it is taken, and can control the pace of the text, pacing it with its associated audio. As mentioned, the service can display images as a slideshow. The service can change the timing of the images such that a device displays an image for a certain interval, depending on the number of images, or such that the image changes as mentioned in the article. In this way, the service can display the text of an article or book so that consumers can read along or view the text as they are listening to the file. The service can scroll text in a similar manner to a ticker and direct the flow of text. The service can also add image effects, such as fly in, wave in or out, and fade in or out.

The service can create many types of video products, including the following:
Travel companions—slideshows with images and relevant audio;
Language packs—slideshows with graphics and corresponding words in a given language. For example, a bathroom image can be displayed with the word “bathroom” in the appropriate language and can play a sound clip at the same time;
Comic books—slideshows of comic books;
Music videos—slides of images associated with a particular song. Images, such as family photos, can be selected by consumers, or can be gathered based on keywords or lyrics, such as if a playing song contains the word “rose,” a rose graphic could be displayed when it is mentioned;
Weather forecasts—showing weather slideshows with appropriate graphics;
Enhanced podcasts—taking any audio podcast and placing images, advertising, or video so that it no longer is just an audio file but now is a video with the original podcast as the audio layer;
Text books—taking any text book and converting it to video. For example, the audio of the book “Da Vinci Code” can be accompanied by a picture of the Mona Lisa when the consumer listens to the portion of the book that discusses that painting; and
Video magazines—video podcast of any magazine that allow consumers to get an abbreviated version of what is in a current issue.

### Advertising

The advertising service is another aspect of the invention. The files generated by the service can contain advertising in the form of audio and video. For both types of output, the text-to-speech voices can be used to create audio commercials or an existing commercial (i.e. a radio advertisement) can be inserted into the file. With the video files additional multimedia can be used to support the audio message. This includes, for example, the logo of the advertiser or any other graphic. Additionally, the video service can support video advertising. For a text-to-speech ad, the advertiser must provide the text they wish to have the text-to-speech engine read. Once the text is received, an audio file will be created for the commercial. For a pre-recorded commercial, the advertiser will provide an audio file to be used. If transition words are required to introduce the commercial (e.g. “but first a word from our sponsor”) a separate audio file can be created for this message that can be inserted before the commercial.

The advertising creation process has the same level of functionality as described with the services above. It is just another form of content that is submitted to the service (i.e., it can be created with multiple voices, contain music, etc). The advertising is also managed by the XML timeline used by the service so that it inserts the advertising message as defined by the client. This can be in the form of a pre-roll, post-roll, in the middle of a story, and so forth. Since the service creates multiple files for each portion of the audio and video, this allows the advertising to be placed between any one of those files. The resulting output is cohesive audio or video file that includes all of the sub files, advertising, music and multimedia.

In some aspects of the invention, the advertising service stores additional information in the database that allows it to properly schedule the advertising in the appropriate file. The additional information can include the date and time interval for the schedule advertising which enables the system to change advertising based on client preferences. As examples, a client could choose to change advertising every year, every month, every week, every day, and even every minute. The advertising service enables multiple files to have different advertising messages inserted so that a content provider can sell concurrent sponsorships on different files. For example, a newspaper content provider might sell an audio sponsorship to “Microsoft” for the technology section of their content and sell another audio sponsorship to “Goldman Sachs” for the business section. The advertising service also inserts advertising messages based on keywords within the article. For example, if an article contains the words “operating system,” the service might insert a message from a technology company. Commercials can also be based on a specific topic or be personalized based on the preferences or habits of the users or customers gathered by the service or by the client.

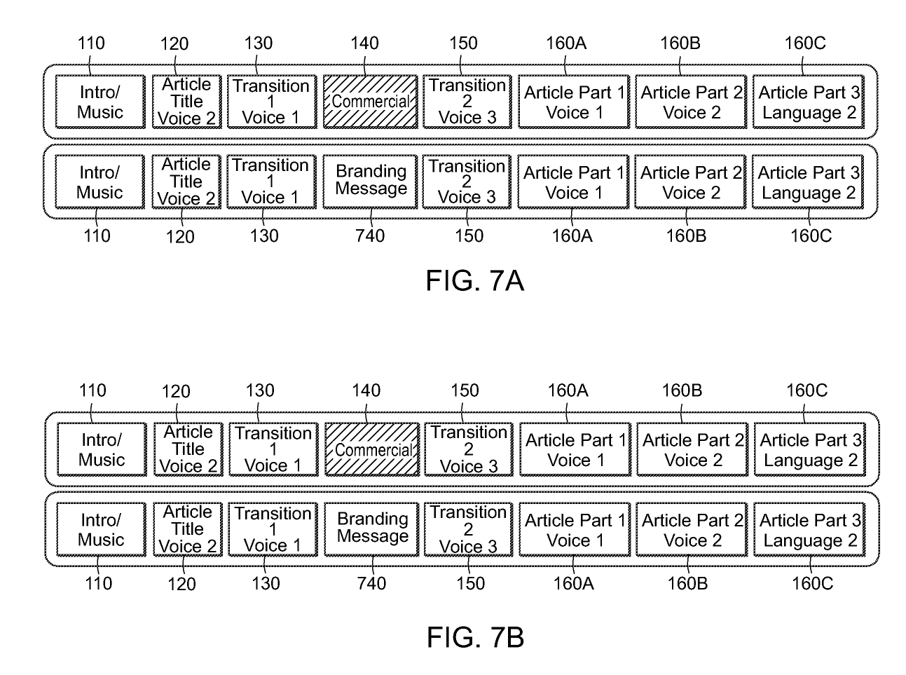

Once the advertising message is set to expire, the advertising service will run through each article it has created and remove the advertising message that it had previously inserted and instead replace it with the new advertising message or a default branding message defined by the content provider. For example, if Microsoft has purchased a sponsorship of files for the month of November on a particular section, then on December 1^{st} all audio files containing that message will be re-created with either a new ad from a different sponsor or if no sponsorship is sold then a branding message from the content provider. FIG. 7 illustrates how an audio file may change over time. FIG. 7A illustrates a podcast that contains commercial audio file 140 and branding message 740. FIG. 7B illustrates a podcast that contains commercial audio file 140 and a branding message 740. However, commercial audio file 140 in FIG. 7A has different content than commercial audio file 140 in FIG. 7B. The service can insert commercial file 140 from FIG. 7A in each audio file for month 1 for a particular section and commercial file 140 from FIG. 7B into each audio file for month 2 for that same section, while always inserting the same branding message 740 for other sections that do not have advertising.

Advertising can also be included in the naming of an audio or video file so that it is displayed when played on any device. This is done by changing the naming fields or ID3 tags of the audio or video. For example, an audio file can be named “Sponsored by Microsoft” instead of the article's title. The service can also stream or digitally insert an audio/video message or commercial before an audio/video file is played.

In cases where there is an audio/video (flash) player being utilized to play the content from a website, the advertising service can be utilized to digitally stream in the adverting so that the advertisement does not get inserted into the physical file. In addition to streaming ad messages, the advertising service can also manage banner ads that are sold when using the audio/video player. The advertising stream and banner ads can be received from multiple 3^{rd} party vendors, such as DoubleClick.

Reporting statistics is another optional element of the advertising service. The service can provide details and reports of all files downloaded or otherwise received by consumers. The service can provide clients with audio download statistics based on any metric, including, for example, file name, date, and section. The service can additionally provide statistics for the most downloaded or the most popular content. The service can also track and provide statistics on how long a consumer listened to a file and where in the file the consumer stopped listening. This can be done via a media player that when used sends messages to the web server indicating that a user is listening a file and has clicked play and sends another message when the file is stopped or ends. The statistics report can be generated on a daily basis and be sent to the client directly.

### Architecture

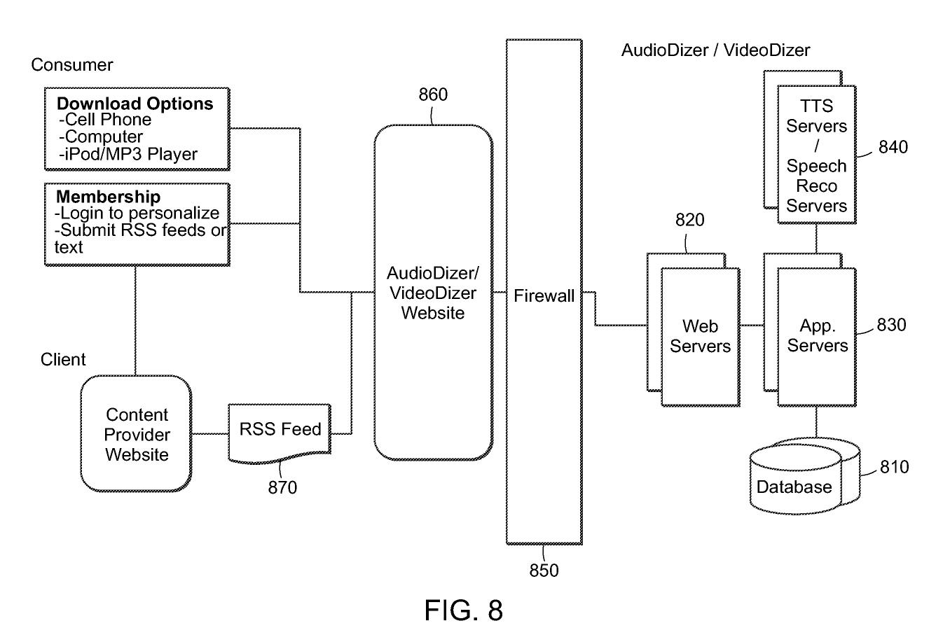

As illustrated in FIG. 8, the architecture of the service generally includes at least six components, although they can reside in more or fewer physical locations. The service itself includes databases 810, web servers 820, application servers 830, text-to-speech servers and speech recognition servers 840, and a firewall 850. The architecture is designed to balance the load of processing and downloading traffic.

Web servers 820 are utilized to receive the submitted text, host the audio and video files for distribution, and host website 860 for the services. Clients can log into the service and create an account that enables them to save their preferences. When they are logged in, they can submit content in a free text form, upload a document in any format, or provide RSS feed 870. They can also submit text or files for the advertising that is required in their files and schedule it so that is created with their files. Once the text is received, it is sent to the application server where is it processed by the features mentioned above. Application servers 830 insert the information to queue the multiple voices, phonetic dictionary, transition words, and so forth and generate the XML timeline. Databases 810 stores all the relevant information which includes the preferences of the content provider and consumer. After the XML timeline has been created, each of the components of the content are sent to TTS servers 840 or processed to create video. The final process is to merge the individual files with the advertising and music to output a single cohesive file that can be downloaded. All of these components sit behind firewall 850. The exemplary architecture of FIG. 8 is also used for the video portion of the service (referred to as “VideoDizer” in the figure).

The files generated by the service can also be distributed via streaming, downloading, or broadcasting. Content providers can link to the files so that they can make them available to their consumers on their site. Content providers can link to the files so that consumers can download them directly or can stream the files using an audio/video player. A podcast RSS feed is also created by the service to allow consumers to subscribe to the files. This enables consumers to get the latest files without having to revisit the site on a regular basis. Furthermore, these RSS feeds can be submitted to numerous podcasts (audio and video) aggregation sites such as iTunes, podcast.com, etc so that consumers can utilize their content aggregator of choice to download the files. Files can be played on any audio or video enabled device including, for example, computers, iPods, and cell phones. Broadcasting content can be done via internet radio or satellite radio. Playlists can also be created for multiple stories or books so that different sources can be played together or so that multiple stories from the same source can be played continuously.

Consumers can also create an account on the website in order to manage which content they wish to subscribe to as well as store their personal preferences for file output. All of this information is stored in the database.

Many of the components described here and much of the functionality is or can be implemented in software, which can be stored in a computer-readable medium, such as optical or magnetic, and executed by a processor.

What is claimed:

1. A method comprising:
receiving a text file including text content;
converting the text content into audio content such that the audio content allows a user to listen to an audio version of the text content, the conversion using text-to-speech technology in which one or more of a plurality of text-to-speech voices can be used to convert the text content to audio content; and
creating a podcast file from the audio content,
wherein the converting includes identifying one or more words within the text content and wherein the text-to-speech voices are selected automatically based at least in part on the identified words in the text content.

2. The method of claim 1, wherein the text-to-speech voices are representative of both male and female voices.

3. The method of claim 2, wherein the text-to-speech voice representative of the male voice is selected based at least in part on words in the text content suggestive of a male speaker, and wherein the text-to-speech voice representative of the female voice is selected based at least in part on words in the text content suggestive of a female speaker.

4. The method of claim 1, wherein the text-to-speech voices are representative of more than one geographical accent, and wherein the text-to-speech voices are selected based at least in part on identified words suggestive of a geographic location.

5. The method of claim 1, wherein the text-to-speech voices are representative of different speeds of reading the text content.

6. The method of claim 1, further comprising correcting the pronunciation of at least one word in the podcast.

7. The method of claim 1, further comprising:
adding one or more speech references to the text content; and
selecting between the text-to-speech voices based at least in part on the one or more speech references.

8. The method of claim 7, wherein the speech reference is indicative of the sex of a speaker.

9. The method of claim 7, wherein the speech reference is indicative of the geographic location of a speaker.

10. The method of claim 7, wherein the speech references are application program interfaces.

11. The method of claim 1, further comprising using a phonetic dictionary to improve the pronunciation of at least one text-to-speech word.

12. The method of claim 1, wherein the podcast is an audio podcast.

13. The method of claim 1, wherein the podcast is a video podcast.

14. The method of claim 1, wherein the text-to-speech voices are representative of more than one language, and wherein the text-to-speech language is selected based at least in part on text content suggestive of a geographic location and/or a language.

15. A system comprising:
an interface for receiving a text file including text content;
a processor for converting the text content into audio content such that the audio content allows a user to listen to an audio version of the text content, the conversion using text-to-speech technology in which one or more of a plurality of text-to-speech voices can be used to convert the text content to audio content, and for creating a podcast file from the audio content,
wherein the processor for converting identifies one or more words within the text content and wherein the text-to-speech voices are selected automatically based at least in part on the identified words in the text content.

16. The system of claim 15, further comprising:
an interface for receiving video content from a media source, wherein the podcast is a video podcast, and wherein the video content is associated with the audio content in the podcast file.

17. The system of claim 15, wherein the text-to-speech voices are representative of both male and female voices, and wherein the text-to-speech voice representative of the male voice is selected based at least in part on words in the text content suggestive of a male speaker, and wherein the text-to-speech voice representative of the female voice is selected based at least in part on words in the text content suggestive of a female speaker.

18. The system of claim 15, wherein the text-to-speech voices are representative of more than one geographical accent, and wherein the text-to-speech voices are selected based at least in part on identified words suggestive of a geographic location.

19. The system of claim 15, wherein the text-to-speech voices are representative of different speeds of reading the text content.

20. The system of claim 15, wherein the text-to-speech voices are representative of more than one language, and wherein the text-to-speech language is selected based at least in part on words in the text content suggestive of a geographic location and/or a language.
